(19) United States
(12) Patent Application Publication
(10) Pub. No.: US 2008/0186993 A1
(43) Pub. Date: Aug. 7, 2008

(54) Method of data transfer using TCP/IP protocol in a microcomputer environment

(76) Inventor: Richard Dellacona, Corona del Mar, CA (US)

Correspondence Address: PATENT LAW & VENTURE GROUP, 2424 S.E. BRISTOL, SUITE 300, NEWPORT BEACH, CA, 92660, US

(21) Appl. No.: 11/702,243

(22) Filed: Feb. 3, 2007

(51) Int. Cl. H04L 12/56

(52) U.S. Cl. 370/423

(57) ABSTRACT

A method of data interchange within one or a network of microcomputers, wherein the microcomputers each have plural devices engaged for communication over a bus structure, the method including the steps of installing a TCP/IP protocol instruction set in each of the devices and in an operating system of each of the microcomputers in the network, and directing data transfers between the devices of all of the microcomputers over the bus structures of all of the microcomputers using packet switching protocol, thereby enabling said data transfers to be made within each of the microcomputers and between the microcomputers.

### BACKGROUND OF THE INVENTION

1. Field of the Present Disclosure

This disclosure relates generally to data transfer within microcomputers and their network environments and more particularly to the use of packet switching techniques in such environments.

2. Description of Related Art Including Information Disclosed Under 37 CFR 1.97 and 1.98

Marce et al, U.S. Pat. No. 6,880,017 discloses a data communication network operated under the TCP/IP suite of protocols wherein the invention adds an adaptive streaming (AS) layer, inserted between the IP and the TCP protocol layers, in which the received data packets of each open TCP connection are temporarily queued and from where they are first reordered then, delivered to the TCP layer at a pace matching the optimal receiving rate of TCP connections. Thus, the invention adds a rate-based transmission mechanism to the TCP layer for the received data packets so as to better adapt to higher-speed communication lines and to reduce drastically the burstiness of the TCP flow control.

Gonsoulin et al, US application 20040051650 defines methods and apparatus for communicating between a MWD or LWD logging tool and a surface processor, such as a PC, using a high speed transmission control protocol-internet protocol (TCP-IP) based connection link. Logging tool sensor response is stored in memory within the tool while logging. The link is removably attached to a data port in the tool when the tool is subsequently removed from the borehole. Stored sensor response information is transferred very rapidly from tool memory as TCP-IP data packets. Transmission is two-way thereby allowing commands to be transmitted from the PC to the tool for control of the tool and the data acquisition function of the tool. The two-way data transmission function can be performed at one or more PC's remote from a drilling rig using a commercially available TCP-IP hub and the internet.

The related art described above discloses certain aspects in use of the TCP/IP protocol. However, the prior art fails to disclose the use of packet switching protocol for data transfer in an interrupt controlled microcomputer. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

The present invention is a method of data interchange within one or a network of microcomputers, wherein the microcomputers each have plural devices engaged for communication over a bus structure. The network allows the bus structures of the microcomputers to interchange data. The method includes the steps of installing a TCP/IP protocol instruction set in each of the devices and in an operating system of each of the microcomputers in the network, and directing data transfers between the devices of all of the microcomputers over the bus structures of all of the microcomputers using packet switching protocol, thereby enabling data transfers to be made within each of the microcomputers and between the microcomputers in a highly efficient manner.

A primary objective inherent in the above described apparatus and method of use is to provide advantages not taught by the prior art.

A further objective is to accelerate data processing in a microcomputer system.

A further objective is use TCP/IP protocol within a microcomputer system.

A further objective is to transfer data using packet switching protocol.

A further objective is to enable system scaling to include devices of other computers.

A further objective is to include large numbers of PCI devices in a microcomputer network.

A further objective is to add and remove devices or computers from a network of microcomputers without restarting the entire system.

A further objective is to improve network security by associating data with an IP number.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a diagram showing in schematic form, the devices and interconnects of a microcomputer; and

FIG. 2 is a table describing a TCP/IP packet.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

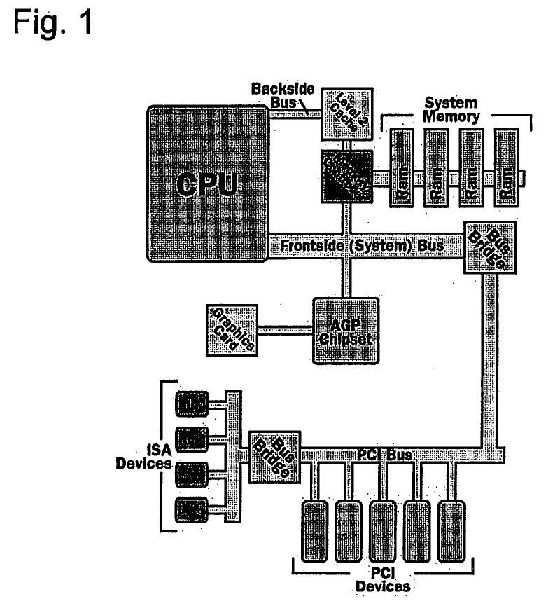

The present invention is a system and method for communication of information in the form of data and programs; referred to herein jointly as “data,” via one or more computer bus structures. The system is preferably a microcomputer of contemporary design, as shown in FIG. 1, while the method of this invention is novel as a contemporary microcomputer protocol and provides a remarkable improvement in operating speed and data handling capacity. The term “microcomputer” is used throughout this specification, but the present method also applies to any electronic computing device including large frame computers and hand-held computing devices such as cell phones and PDAs, etc.

A contemporary microcomputer system uses several buses to transfer data from one device to another device within the system. Typical devices that are connected via a bus include hard disks, memory, sound systems, video systems and so on. For example, a monitor screen is driven by a graphics card which plugs into a bus. The graphics card talks to the system processor (CPU) using the bus as a communication path. A typical microcomputer system has two main buses, one known as the system bus or local bus, connects the CPU and the system memory. This is the fastest bus in the system. A second one is a slower bus for communicating with devices like hard disks and sound cards. One very common bus of this type is known as the Peripheral Device Interconnect (PCI) bus. These slower buses connect to the system bus through a bridge chip, which is a part of the system's chipset and acts to integrate data from other buses to the system bus.

Technically there are other buses as well. For example, the Universal Serial Bus (USB) is a way of connecting devices such as cameras, scanners and printers to the system. It uses wires to connect to these devices, and many devices can share the wires simultaneously. Firewire is another bus, used today mostly for video cameras and external hard drives.

The PCI provides direct access to system memory for connected devices, but uses a bridge chip to connect to the frontside bus and therefore to the CPU. Basically, this means that it is capable of high performance while eliminating the potential for interference with the CPU. The PCI bridge chip regulates the speed of the PCI bus independently of the CPU's speed. This provides a higher degree of reliability.

A frontside bus is a physical connection that connects the processor to most of the devices in the system, including main memory, hard drives and PCI slots. A backside bus is a separate connection between the CPU and a Level 2 cache. This bus operates at a faster speed than the frontside bus, usually at the same speed as the CPU allowing caching to work as efficiently as possible. Backside buses are typically integrated into the CPU.

In the prior art method of data transfer using the standard PCI bus specification and protocol, each device is assigned an interrupt request line (IRQ), a hardware line over which the device is able to send interrupt signals to the CPU. Typically there are no more than sixteen of these hardwired interrupt lines. When an interrupt signal is received, current operation is placed on hold, clearing the bus, and the data signal from the interrupting device is transmitted over the bus and then handled by the CPU. In some cases the interrupt signal is placed on hold until it can be handled, if the CPU cannot be interrupted at that instant. As can be seen, in this scenario, interrupt requests can stack up and the transfer of data over the bus can be relatively slow as the CPU handles each data transfer in a serial manner while all others wait. The CPU knows that the data it is handling corresponds with the specific interrupt line it is addressing. If, for instance, the data relates to a keystroke executed on the keyboard, the CPU processes it and then sends an instruction to the video controller using its interrupt line which alerts the screen controller to be ready to receive the keystroke data over the bus and to place it appropriately on screen.

Transmission Control Protocol/Internet Protocol (TCP/IP) is the suite of communications protocols used to connect hosts on the Internet. Any number of data packets can be transmitted at the same time. TCP/IP uses several protocols, the two main ones being TCP and IP. As is well known, these protocols can be implemented either in hardware or software. In the present system, each device sends an interrupt signal to the CPU or bridge chip as described above, when the device is ready to send data. Again, the CPU or bridge chip places each interrupt request in its stack. However, the devices do not wait for the interrupt to be acknowledged by the CPU or bridge chip before placing the data in RAM. TCP enables two devices to establish a connection on the bus and exchange streams of data, whereas the IP protocol enables Packet Switching. TCP guarantees delivery of data and also guarantees that packets will be delivered in the same order in which they were sent. One of the key features of a packet is that it contains the destination address in addition to the data being sent. Each packet is then transmitted as an independent transmission. Once all the packets forming a message arrive at the destination, they are recompiled into the original data. Most modern wide area network (WAN) protocols, including TCP/IP, X.25, ATM and Frame Relay, and are based on packet-switching technologies and any one of these or similar packet-switching protocols may be applied in the present invention. Since each packet defines its destination it does not need to await an interrupt cycle to be sent, but can move on the bus and arrive at the destination device at any time. In fact, the CPU need not handle data transfers but rather can move through the interrupt cycles very rapidly allowing data to move much more quickly between sending and receiving devices.

In the present invention method, plural transfers of data between devices are able to move over the bus simultaneously within frames or packets as defined by the TCP/IP protocol. The physical structure of the system can be identical to that described above, however, the system operates in a much more efficient manner. In this method, TCP/IP protocol software is installed in the system resulting in the devices and the operating system operating in TCP/IP mode. All data transfers are then directed on the system bus and bridge bus in accordance with TCP/IP protocol. Therefore, at every interrupt cycle, all framed data is placed on the bus without waiting. Instead of devices being restricted from data transfer to only their respective interrupt cycles, all data is able to move over the bus simultaneously. In this scheme, the basic commands between the command interpreter of the operating system and the bios are superseded by adding a modified protocol wherein commands are matched to newly created TCP/IP commends on a one-for-one basis. A look-up table in memory matches these commands and then addresses the chipsets. The system can be scaled by daisy-chaining additional computers without limit so that the bus structure can be quite large by avoiding the burden of the typical inverted Christmas-tree of interrupts and exchange between bus level language and TCP/IP.

To enable the computer to use TCP/IP protocol each of the devices in the computer is assigned an address. Each set of data that is transferred between device A and device B is broken into parts of a certain size, in bytes. These are the packets, also referred to by “frames,” “blocks,” “cells,” and “segments.” Each packet sent from device A carries information that enables it to get to device B. This information includes the address of device A, the address of device B, the total number of packets in the transmission, and the number of the particular packet, i.e. 74 out of 92 for example. The packets carry the data in the TCP/IP protocols. Each packet contains part of the body of the set of data being transmitted. A typical packet contains perhaps 1,000 or 1,500 bytes. Each packet is then placed on the bus at the next interrupt cycle.

Each packet has three parts, a header, a body and a trailer. The body is also referred to as a “payload,” and the trailer is also referred to as a “footer.” The header contains information defining: length of packet, synchronization, packet number, type of information, i.e., text, graphics, audio and so on, destination address and originating address. The body comprises the data that the packet is delivering to the destination, and the trailer typically contains a couple of bits that tell the receiving device that it has reached the end of the packet. Preferably, the trailer includes a method of error checking such as cyclic redundancy check (CRC). CRC takes the sum of all the is in the payload and adds them together. The result is stored as a hexadecimal value in the trailer. The receiving device adds up the 1s in the payload and compares the result to the value stored in the trailer. If the values match, the packet is good. But if the values do not match, the receiving device sends a request to the originating device to resend the packet.

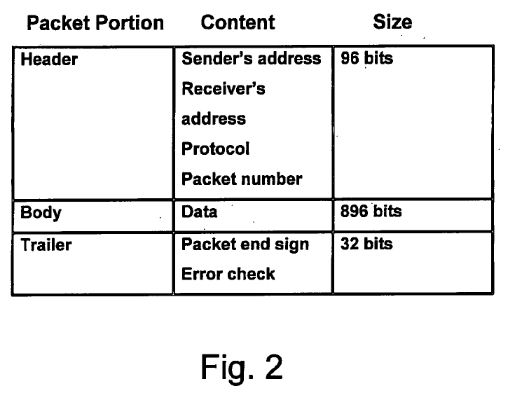

As an example, a transmission containing 3,500 bits (3.5 kilobits) is sent using using fixed-length packets of 1,024 bits (1 kilobit). The header of each packet is 96 bits long and the trailer is 32 bits long, leaving 896 bits for the payload. The 3,500 bits of payload is broken into four packets, three containing 896 bits each and one with 812 bits. FIG. 2 is a table defining one of the packets. Each packet's header contains the proper protocols, the address of the originating device, the address of the destination device, and the packet number (1, 2, 3 or 4 since there are 4 packets). There is no router needed in the computer to direct each packet, because each receiving device is programmed to know which sending device is should receive packets from. Once a packet is placed on the bus it is immediately sensed by its receiving device and accepted. At this time, the receiving device strips the header and trailer off each packet and reassemble the transmission by concatenating the bodies based on the numbered sequence of the packets.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A method of data interchange within a microcomputer, wherein the microcomputer has plural devices engaged for communication over a bus structure, the method comprising:
a) installing a TCP/IP protocol instruction set in each of the devices and in an operating system of the microcomputer; and
b) directing data transfers between the devices over the bus structure using packet switching protocol.

2. The method of claim 1 further comprising the step of packetizing at least one of the data transfers to produce a plurality of data packets.

3. The method of claim 2 further comprising the step of transferring all packetized data that is stacked for dispatch from any one of the devices onto the bus structure at each next interrupt cycle.

4. The method of claim 1 further comprising the step of assigning each of the devices a TCP/IP protocol address.

5. The method of claim 1 further comprising the step of breaking each of said data transfers into parts of a certain size, in bytes.

6. The method of claim 2 further comprising the step of providing, in each of the data packets, an address of a sending device, an address of a receiving device, a total number of packets in the current transmission, and a sequence number of each packet.

7. The method of claim 2 further comprising the step of providing, in each of the data packets, a length of packet, a synchronization, a packet number, a type of information, a destination address, an originating address, and an end-of-packet indicator.

8. The method of claim 7 further comprising the step of providing, in each of the data packets, a means for error checking.

9. The method of claim 8 wherein the error checking means is cyclic redundancy checking.

10. The method of claim 2 further comprising the steps of: including in each packet a header, a body and a trailer, and, upon receipt of each of the packets, striping the header and the trailer off the packet and reassembling the transmission by concatenating the bodies of the packets based on a numbered sequence of the packets.

11. A method of data interchange within a network of microcomputers, wherein the microcomputers each have plural devices engaged for communication over a bus structure, the method comprising:
c) installing a TCP/IP protocol instruction set in each of the devices and in an operating system of each of the microcomputers in the network; and
d) directing data transfers between the devices of all of the microcomputers over the bus structures of all of the microcomputers using packet switching protocol, thereby enabling said data transfers to be made within each of the microcomputers and between the microcomputers.

12. The method of claim 11 further comprising the step of packetizing at least one of the data transfers to produce a plurality of data packets.

13. The method of claim 12 further comprising the step of transferring all packetized data that is stacked for dispatch from any one of the devices onto the bus structure at each next interrupt cycle.

14. The method of claim 11 further comprising the step of assigning each of the devices a TCP/IP protocol address.

15. The method of claim 11 further comprising the step of breaking each of said data transfers into parts of a certain size, in bytes.

16. The method of claim 12 further comprising the step of providing, in each of the data packets, an address of a sending device, an address of a receiving device, a total number of packets in the current transmission, and a sequence number of each packet.

17. The method of claim 12 further comprising the step of providing, in each of the data packets, a length of packet, a synchronization, a packet number, a type of information, a destination address, an originating address, and an end-of-packet indicator.

18. The method of claim 17 further comprising the step of providing, in each of the data packets, a means for error checking.

19. The method of claim 18 wherein the error checking means is cyclic redundancy checking.

20. The method of claim 12 further comprising the steps of: including in each packet a header, a body and a trailer, and, upon receipt of each of the packets, striping the header and the trailer off the packet and reassembling the transmission by concatenating the bodies of the packets based on a numbered sequence of the packets.
